(19) United States
(12) Patent Application Publication
(10) Pub. No.: US 2026/0213589 A1
(43) Pub. Date: Jul. 23, 2026

(54) STATOR AND METHOD FOR PRODUCING A STATOR

(71) Applicant: Schaeffler Technologies AG & Co. KG, Herzogenaurach (DE)

(72) Inventors: Wolfgang Haas, Bühl (DE); Jan Hoffmann, Muggensturm (DE); Johannes Dollansky, Bühlertal (DE); Michael Marsetz, Ettlingen (DE); Michael Lamm, Sasbach (DE); Jürgen Seifermann, Ottenhöfen (DE); Tobias Doll, Renchen (DE); Moritz Wagenblatt, Erfweiler (DE); Volker Lang, Lauf (DE)

(73) Assignee: Schaeffler Technologies AG & Co. KG, Herzogenaurach (DE)

(21) Appl. No.: 19/140,671

(22) PCT Filed: Nov. 20, 2023
(86) PCT No.: PCT/DE2023/100893

§ 371 Date: Jun. 18, 2025

(30) Foreign Application Priority Data
Dec. 19, 2022 (DE) 10 2022 133 849.5

(51) Int. Cl. H02K 1/16; H02K 3/34; H02K 3/487; H02K 15/026; H02K 15/121; H02K 15/13

(52) U.S. Cl. CPC H02K 1/165; H02K 3/345; H02K 3/487; H02K 15/026; H02K 15/121; H02K 15/13

(57) ABSTRACT

The invention relates to a stator (1) of an electric machine (2), in particular for a drive train (3) of a motor vehicle (4), comprising a stator body (5) having a plurality of stator grooves (6) extending axially through the stator body (5), in which stator grooves a stator winding (8) consisting of a plurality of electrical conductors (7) is received, which stator winding exits on both end faces (10a, 10b) of the stator body (5), forming a winding head (9a, 9b) in each case, wherein in or on the stator body (5) at least one plastic injection-moulding element (11) is injection-moulded in or on the stator body (5).

### CROSS-REFERENCE TO RELATED APPLICATIONS

This application is a U.S. national stage application under 35 U.S.C. § 371 that claims the benefit of priority under 35 U.S.C. § 365 of International Patent Application No. PCT/DE2023/100893, filed on Nov. 20, 2023, designating the United States of America, which in turn claims the benefit of priority under 35 U.S.C. § § 119, 365 of German Patent Application No. 102022133849.5, filed on Dec. 19, 2022, the contents of which are relied upon and incorporated herein by reference in their entirety.

### FIELD OF THE DISCLOSURE

The present disclosure relates to a stator of an electric machine for a drive train of a motor vehicle, comprising a stator body having a plurality of stator slots which extend axially through the stator body and in which stator slots a stator winding consisting of a plurality of electrical conductors is received, which stator winding exits at the two end faces of the stator body so as to form a winding head in each case. The disclosure further relates to a method for producing a stator.

### BACKGROUND OF THE DISCLOSURE

Electric motors are increasingly being used to drive motor vehicles to provide alternatives to internal combustion engines that require fossil fuels. Significant efforts have already been made to improve the suitability of electric drives for everyday use and also to be able to offer users the driving comfort which they are accustomed to.

A detailed description of an electric drive can be found in an article in the German automotive magazine ATZ, volume 63, 05/20 6, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle, which comprises an electric motor arranged concentrically with respect to a bevel gear differential. Such drive units are also referred to as e-axles.

In addition to purely electrically operated drive trains, hybrid drive trains are also known. Such drive trains of a hybrid vehicle usually comprise a combination of an internal combustion engine and an electric motor, and enable, for example in urban areas, a purely electric mode of operation while at the same time permitting both sufficient range and availability, in particular when driving cross-country. In addition, drive can also be provided by the internal combustion engine and the electric motor at the same time in certain operating situations.

For the development of electric machines, such as electric machines for hybrid or fully electric motor vehicles or also for wheel hub drives, fundamentally different winding technologies for a stator of an electric machine are known.

Electric machines which have a hollow-cylindrical stator, i.e. are designed as internal rotor machines, and which are configured for use as a traction drive of a motor vehicle often have a stator winding with a rectangular cross-section in order to achieve a high power density. In electric machines intended for driving motor vehicles, the stator windings are therefore typically designed as I-pin or hairpin windings. In some cases, for example, substantially I-or U-shaped wire segments are introduced into the stator slots from one end face of the stator and then shaped at an opposite end face of the stator and connected, for example, by welding.

In the production of such stators, there are various challenges in manufacturing the stators cost-effectively and reliably. Some essential and also cost-intensive production steps are, for example, the electrical insulation of the winding from the slots of the stator by means of insulating paper, the fixing of the individual laminations or laminated cores of the stator by joining using clinching, gluing by bonding varnish or using welding, the forming of the hairpins of a hairpin winding by means of a bending tool, or the closing of the stator slots by means of a slot closing wedge.

### SUMMARY OF THE DISCLOSURE

An object of the disclosure is to provide a stator that is optimized in terms of its production and can be manufactured cost-effectively. A further object of the disclosure is to provide an improved method for producing a stator.

This object is achieved by a stator of an electric machine for a drive train of a motor vehicle, comprising a stator body having a plurality of stator slots which extend axially through the stator body and in which stator slots a stator winding consisting of a plurality of electrical conductors is received, which stator winding exits at the two end faces of the stator body so as to form a winding head in each case, wherein at least one plastic injection-molded element is injection-molded in or on the stator body.

The advantage of this is that a number of different functions can be provided in a component produced by injection molding by means of an injection-molded plastic injection-molded element. These functions of the plastic injection-molded element can include, for example, fixing functions, closing functions, insulating functions, and/or sealing functions.

In this context, a plurality of individual laminations or laminated cores of the stator body can be fixed in position relative to one another by means of the plastic injection-molded element. This can eliminate the need for fixation/stabilization/packaging via bonding varnish, clinching and/or welding, since this is achieved by the plastic injection-molded element.

The plastic used to form the plastic injection-molded element could be a thermoset, such as an epoxy resin, for example, but other plastics are also conceivable in principle. The plastic injection-molded element may be formed from a plastic. In principle, it is also conceivable that the plastic injection-molded element can also be formed from a plurality of different plastics, for example by means of a bi-injection molding process.

A plastic injection-molded element may be designed in one piece. However, it is also conceivable that the plastic injection-molded element is formed in several parts, in which case the plurality of parts of the plastic injection-molded element may be formed from the same plastic.

In principle, it is conceivable for there to be several plastic injection-molded elements in or on the stator.

An aspect of the disclosure is that the plastic injection-molded element is injection-molded in or on the stator body. This means that the plastic injection-molded element has been formed in or on the stator body during the injection molding process and not subsequently arranged as a separate component in or on the stator.

The stator according to the disclosure is intended for use in an electric machine. The electric machine is used to convert electrical energy into mechanical energy and/or vice versa, and generally comprises a stationary part referred to as a stator or armature, and a part referred to as a rotor, which is arranged movably, in particular rotatably, relative to the stationary part. The electric machine may be dimensioned such that vehicle speeds of more than 50 km/h, 80 km/h, and/or 100 km/h can be achieved. The electric motor may have an output of more than 30 kW, 50 kW, and/or 70 kW. Furthermore, it the electric machine may provide speeds greater than 5000 rpm, 10,000 rpm, and/or 12,500 rpm.

The stator can be supplied with current by a power electronics unit, sometimes also referred to as an inverter. A power electronics unit may be a combination of different components that control or regulate a current to the stator and may include peripheral components required for this purpose, such as cooling elements or power supply units. In some embodiments, the power electronics unit contains one or more power electronics components that are configured to control or regulate a current. These may include one or more power switches, such as power transistors. The power electronics unit may have more than two (e.g., three) phases or current paths which are separate from one another and which each have at least one separate power electronics component. The power electronics unit may be designed for controlling or regulating a power per phase with a peak power, in some embodiments continuous power, of at least 10 W, at least 100 W, and/or at least 1000 W. The power electronics unit may be connected to the stator winding of the stator via an HV terminal (HV=high voltage).

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

The stator according to the disclosure can be configured for a radial flux machine. The stator of a radial flux machine usually has a structure which is cylindrical or in the shape of a cylindrical ring and generally consists of a stator body which is formed from electrical steel sheets that are electrically insulated from one another and are structured in layers and packaged to form laminated cores. This structure minimizes the eddy currents in the stator caused by the stator field. Distributed around the circumference, stator slots are embedded into the electrical steel sheet in a manner running parallel to the rotor shaft and receive the stator winding or parts of the stator winding. Depending on the structure towards the surface, the slots can be closed with closing elements, such as closing wedges or covers or the like, to prevent the stator winding from detaching.

The stator body may be designed in one piece. A one-piece stator body may be entirely formed in one piece as viewed over the circumference. The stator body is usually formed from a plurality of stacked laminated electrical steel sheets, with each of the electrical steel sheets being closed to form a circular ring. The individual laminations can be held together in the stator body, for example, by adhesive bonding, welding or screwing.

The stator teeth of the stator may be formed in the stator body. Stator teeth are components of the stator body which are designed as circumferentially spaced, tooth-like parts of the stator body directed radially inwards (internal rotor) or radially outwards (external rotor) and between the free ends of which and a rotor body an air gap for the magnetic field and for the rotative movement of the rotor is formed. The non-magnetic gap between the rotor and the stator is referred to as the air gap. In a radial flux machine, for example, this is a substantially annular gap with a radial width that corresponds to the distance between the rotor body and the stator body.

A stator winding is embedded in the stator slots of the stator according to the disclosure. A stator winding comprises electrically conductive conductors which have a longitudinal extension that is much greater than their diameter. The stator winding can generally have any cross-sectional shape. Rectangular cross-sectional shapes allow high packing densities and consequently high power densities to be achieved. A stator winding may be formed of copper.

The winding may be designed as an I-pin or hairpin winding.

Further advantageous embodiments of the disclosure are specified in the dependent claims. The features listed individually in the dependent claims can be combined with one another in a technologically meaningful manner and can define further embodiments of the disclosure. In addition, the features indicated in the claims are specified and explained in more detail in the description, wherein further embodiments of the disclosure are shown.

According to an advantageous embodiment of the disclosure, it is possible for the stator slots to each have slot sidewalls extending radially in cross-section and a slot base, wherein the plastic injection-molded element completely covers the slot sidewalls and the slot base. The advantage of this embodiment is that the sidewalls and the slot base are coated with a plastic, eliminating the use of a separate insulating paper. It goes without saying that the plastic has electrically insulating properties for this purpose. The plastic injection-molded element may have a substantially uniform layer thickness on the slot sidewalls and the slot base. By completely covering the sidewalls and the slot base, it is also possible to form a fluid seal between the stator slots and the stator body so that the stator can also have fluid cooling of the stator slots as a result. Furthermore, the plastic injection-molded element can be formed on the slot sidewalls and the slot base to support the fixing of the stator laminations or laminated stator cores.

According to an aspect of the disclosure, it is also possible for the stator slots to each have a slot opening extending radially in cross-section, with the plastic injection-molded element closing the slot opening. This makes it possible to close the stator slots radially inwards using the plastic injection-molded element and, for example, to dispense with the slot closing wedges that would otherwise be required.

In some embodiments, the plastic injection-molded element that covers the slot sidewalls and the slot base as well as the plastic injection-molded element that closes the slot opening are formed in one piece (e.g., monolithically).

Furthermore, according to an embodiment of the disclosure, it is possible for the plastic injection-molded element to have a first cylinder ring section which extends axially out of the stator body and which runs radially below the first winding head, and/or for the plastic injection-molded element to have a second cylinder ring section which extends axially out of the stator body and which runs radially above the first winding head, and/or for the plastic injection-molded element to have a third cylinder ring section which extends axially out of the stator body and which runs radially below the second winding head, and/or for the plastic injection-molded element to have a fourth cylinder ring section which extends axially out of the stator body and which runs radially above the second winding head.

One or more of the cylinder ring sections can be used to define different spaces and zones in or on the stator which can have different functions. For example, it would be conceivable to use the first cylinder ring section to define a separation between a wet space and a dry space.

In this context, the first cylinder ring section and/or the second cylinder ring section and/or the third cylinder ring section and/or the fourth cylinder ring section may be formed in one piece (e.g., monolithically) with the plastic injection-molded element that covers the slot sidewalls and the slot base.

In this context, the first cylinder ring section and/or the second cylinder ring section and/or the third cylinder ring section and/or the fourth cylinder ring section may be formed in one piece (e.g., monolithically) with the plastic injection-molded element that closes the slot opening.

According to an embodiment of the disclosure, it is possible for the plastic injection-molded element to have a first connecting section which covers an outer lateral surface of the stator body at least in sections. This makes it possible to realize a thermal decoupling of the stator body from a connecting structure, such as a motor housing or a stator carrier. This can be desirable if the heat from the stator is not intended to be or cannot be transferred to thermally sensitive adjacent structures or components via its outer lateral surface, but instead, for example, specifically via fluid cooling, such as by means of a cooling oil. In this case, the connecting section can be designed to be frictional and/or form-fitting between the stator body and a connecting structure.

In this context, the connecting section can be formed in one piece (e.g., monolithically) with the first cylinder ring section and/or the second cylinder ring section and/or the third cylinder ring section and/or the fourth cylinder ring section of the plastic injection-molded element.

The connecting section may be formed in one piece (e.g., monolithically) with the plastic injection-molded element that covers the slot sidewalls and the slot base.

The connecting section may be formed in one piece (e.g., monolithically) with the plastic injection-molded element that closes the slot opening.

Furthermore, a stator tooth extending axially through the stator body is formed circumferentially between two adjacent stator slots, and the plastic injection-molded element covers one end face of one or more stator teeth in each case. This can improve the slot insulation. In some embodiments of the disclosure, it is also possible for the plastic injection-molded element to have a contour which projects axially out of the end face and which is used as a forming tool during the twisting of the corresponding winding head. The result is that the geometry of the plastic injection-molded element at the end face of the stator body is designed in such a way that, for example, the hairpins of a hairpin winding can be bent directly over this geometry and no additional tool is required. This bending of the stator winding conductors in the winding head region outside the stator body can be referred to as interlacing or twisting.

In this context, the contour may be formed in one piece (e.g., monolithically) with the first cylinder ring section and/or the second cylinder ring section and/or the third cylinder ring section and/or the fourth cylinder ring section of the plastic injection-molded element.

The contour may be formed in one piece (e.g., monolithically) with the plastic injection-molded element that covers the slot sidewalls and the slot base.

In some embodiments, the contour is formed in one piece (e.g., monolithically) with the plastic injection-molded element that closes the slot opening.

Furthermore, in some embodiments, the contour is formed in one piece (e.g., monolithically) with the plastic injection-molded element that forms the connecting section.

In some embodiments, the second cylinder ring section extending axially out of the stator body runs radially above the first winding head and radially below the outer diameter of the stator body, and/or the fourth cylinder ring section extending axially out of the stator body runs radially above the second winding head and radially below the outer diameter of the stator body. This can be used, for example, to thermally decouple a wet space from a connecting structure, such as a motor housing, in order to protect thermally sensitive regions around the stator accordingly from unwanted thermal loading.

According to an embodiment of the subject matter of the disclosure, it is possible for the first cylinder ring section and/or the second cylinder ring section and/or the third cylinder ring section and/or the fourth cylinder ring section to each have at least one form-fitting means for connecting at least one component to the cylinder ring section. This enables further optimized system integration and further elimination of separate components.

The object of the disclosure can also be solved by a method for producing a stator of an electric machine for, for example, a drive train of a motor vehicle, comprising the following steps:
providing a stator with a stator body having a plurality of stator slots which extend axially through the stator body and in which a stator winding consisting of a plurality of electrical conductors can be positioned,
inserting the stator into an injection-molding tool of an injection molding machine,
injection-molding at least one plastic injection-molded element in or on the stator body, and
removing the stator from the injection-molding tool.

An aspect of the disclosure is thus the simplification of production processes and the combination of several functions of previously separate components of a stator in one or more plastic injection-molded elements, which are formed in an injection molding process.

It is understood that the individual functions described and their structural elements can be combined individually or in any combination. For example, it would be possible for the plastic injection-molded element to only realize the slot insulation using plastic, but without the contour for bending the hairpins.

The disclosure is explained in more detail below with reference to figures without limiting the general concept of the disclosure.

### BRIEF DESCRIPTION OF THE DRAWINGS

In the figures:

FIG. 1 shows a schematic block diagram of a motor vehicle having an electric machine;

FIG. 2 shows a schematic cross-sectional view of an electric machine;

FIG. 3 shows a first axial sectional view of a wound stator;

FIG. 4 shows a first perspective axial sectional view of the wound stator known from FIG. 3;

FIG. 5 shows a non-wound stator in a second axial sectional view;

FIG. 6 shows a second perspective axial sectional view of the non-wound stator known from FIG. 5;

FIG. 7 shows a detail cross-sectional view of a first embodiment of a slot closure;

FIG. 8 shows a detail cross-sectional view of a second embodiment of a slot closure;

FIG. 9 shows a detailed view from a radial direction of the winding head of the stator with an axially extending contour formed on the stator teeth for interlacing the electrical conductors;

FIG. 10 shows a detailed view from the radial direction of the non-wound winding head region of the stator with an axially extending contour, formed on the stator teeth, for interlacing the electrical conductors; and

FIG. 11 shows a detailed perspective view of the non-wound winding head region of the stator with an axially extending contour, formed on the stator teeth, for interlacing the electrical conductors.

### DETAILED DESCRIPTION

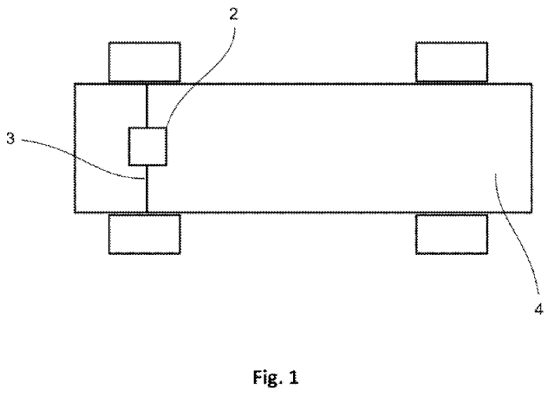

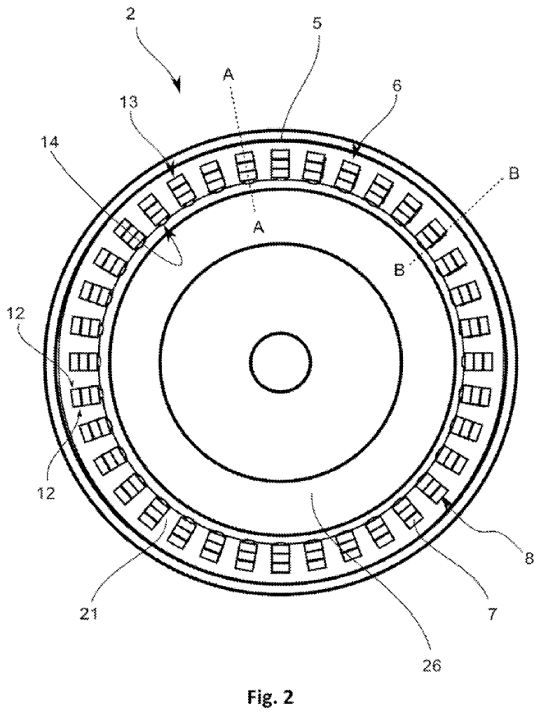

FIG. 2 shows a stator 1 for an electric machine 2 for, for example, a drive train 3 of a motor vehicle 4, as also drawn in FIG. 1.

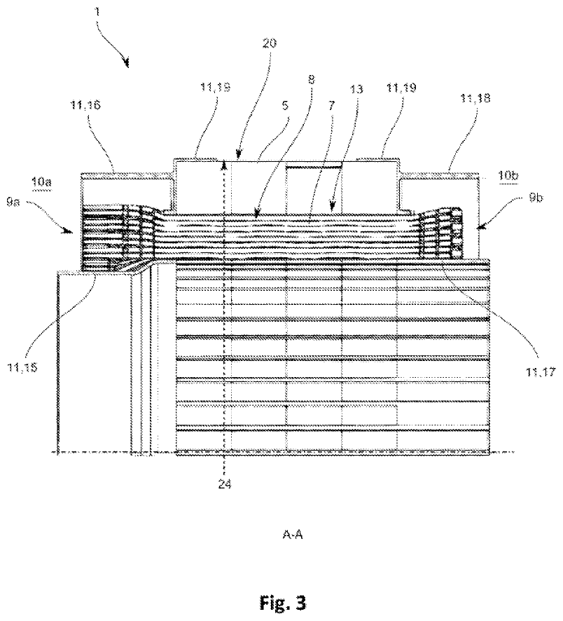

As can be seen from the combined view of FIGS. 1 and 3, the stator 1 comprises a stator body 5 having a plurality of stator slots 6 which extend axially through the stator body 5 and in which a stator winding 8 consisting of a plurality of electrical conductors 7 is received, which stator winding exits at the two end faces 10a, 10b of the stator body 5 so as to form a winding head 9a, 9b in each case. The stator 1 is configured for an internally running radial flux machine and has a correspondingly hollow-cylindrical stator body 5, in which the rotor 26 is rotatably mounted.

At least one plastic injection-molded element 11 is injection-molded in or on the stator body 5.

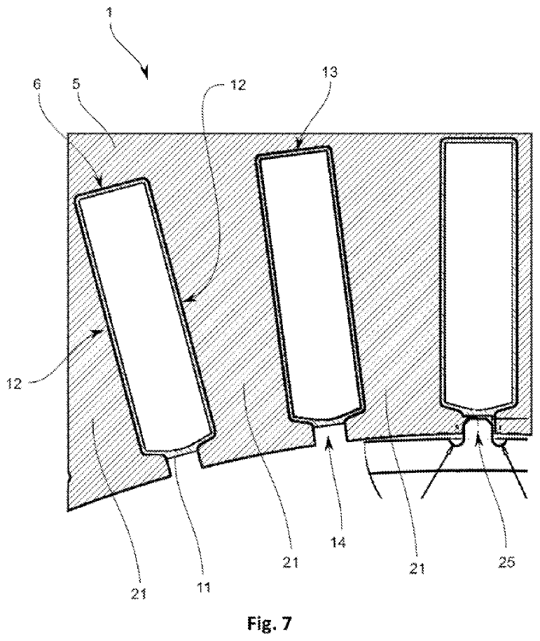

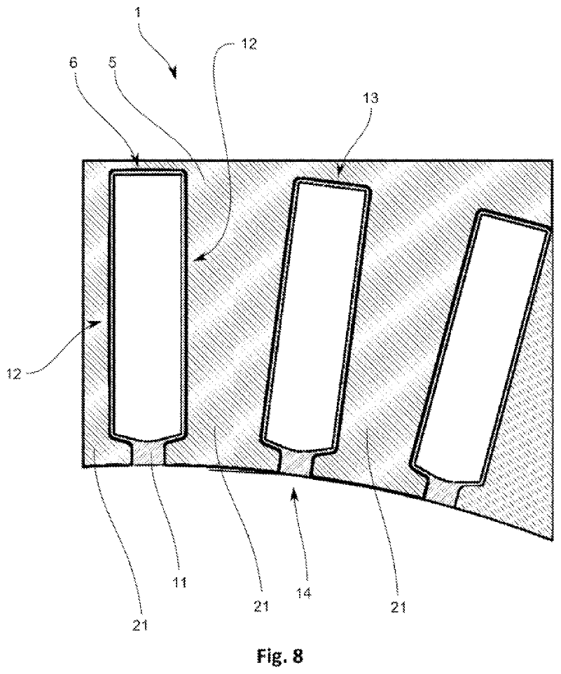

FIGS. 7-8 show that the stator slots 6 each have slot sidewalls 12 extending radially in cross-section and a slot base 13, wherein the plastic injection-molded element 11 completely covers the slot sidewalls 12 and the slot base 13. The stator slots 6 also each have a slot opening 14 extending radially in cross-section, wherein the plastic injection-molded element 11 closes the slot opening 14. FIG. 7 shows an embodiment formed by a tool 25 moving into the slot opening 14 so that the slot opening 14 is closed in the radially upper region of the slot opening 14. This has the advantage that the tool 25 can be guided in the radially inner section of the slot opening 14. FIG. 8 shows an alternative embodiment in which the slot opening 14 is completely filled with plastic, allowing simpler tools to be used.

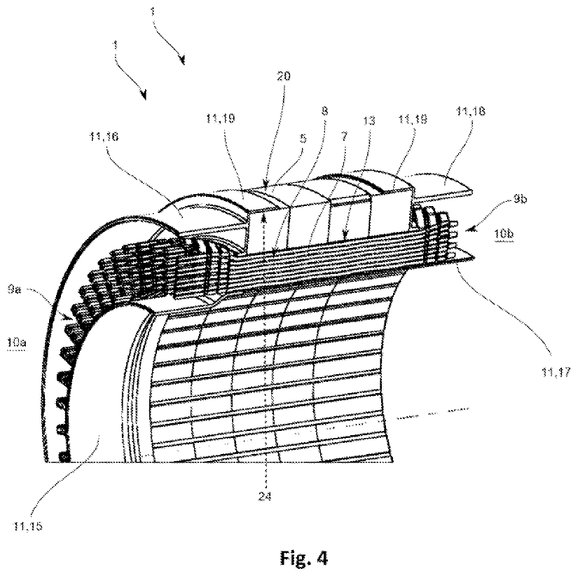

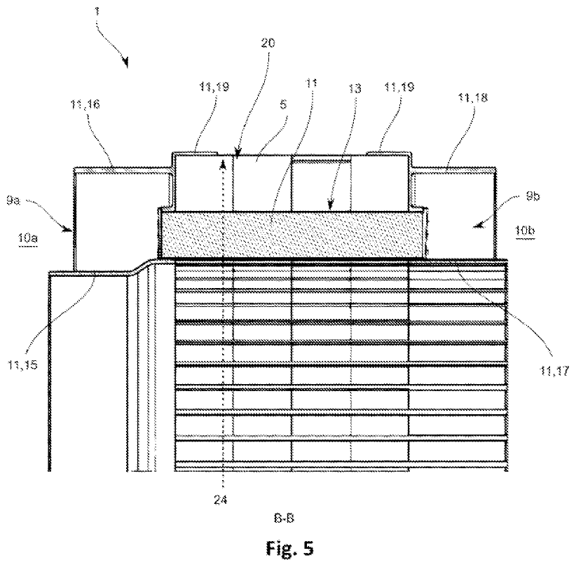

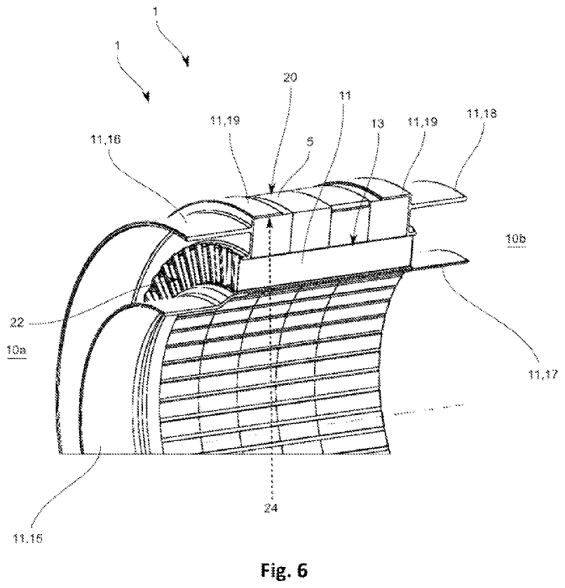

As shown in FIGS. 3-6, the plastic injection-molded element 11 has a first cylinder ring section 15 which extends axially out of the stator body 5 and which runs radially below the first winding head 9a. In the embodiment shown, the plastic injection-molded element 11 also has a second cylinder ring section 16 which extends axially out of the stator body 5 and which runs radially above the first winding head 9a. As a result, the first winding head 9a is surrounded by an annular space which is defined by the first cylinder ring section 15 and the second cylinder ring section 16. It is possible for the cylinder ring sections 15, 16 to be formed in two pieces and have no physical connection to each other, but to have been injection-molded onto the stator body 5 in the same injection molding process. In this case, the cylinder ring sections 15, 16 are formed from the same plastic.

Furthermore, a plastic injection-molded element 11 has a third cylinder ring section 17 which extends axially out of the stator body 5 and which runs radially below the second winding head 9b, and a fourth cylinder ring section 18 which extends radially out of the stator body 5 and which runs radially above the second winding head 9b. As a result, the second winding head 9b is also surrounded by an annular space defined by the third cylinder ring section 17 and the fourth cylinder ring section 18. In this case, it is also possible for the cylinder ring sections 17, 18 to be formed in two pieces and have no physical connection to each other, but to have been injection-molded onto the stator body 5 in the same injection molding process, and for the cylinder ring sections 15, 16 to thus be formed from the same plastic.

FIGS. 3-6 also show that the second cylinder ring section 16 extending axially out of the stator body 5 runs radially above the first winding head 9a and radially below the outer diameter 24 of the stator body 5. The fourth cylinder ring section 18 extending axially out of the stator body 5 is also formed radially above the second winding head 9b and radially below the outer diameter 24 of the stator body 5. This allows further thermal decoupling of the winding head region from a connecting structure (not shown).

FIGS. 3-6 also show that the plastic injection-molded element 11 has a first connecting section 19, which covers an outer lateral surface 20 of the stator body 5 at least in sections. This can achieve thermal decoupling from a connecting structure that holds the stator 1.

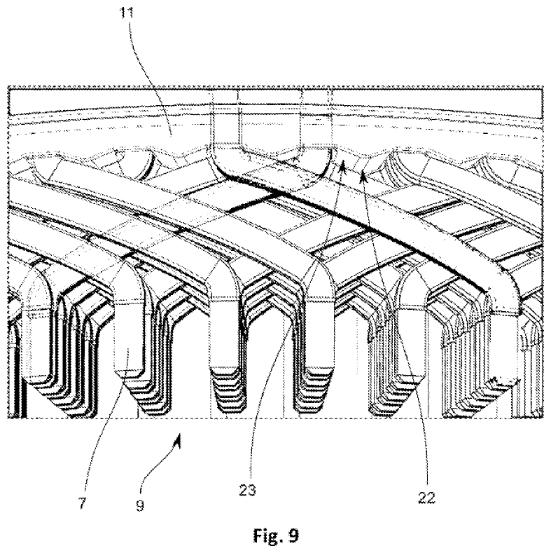

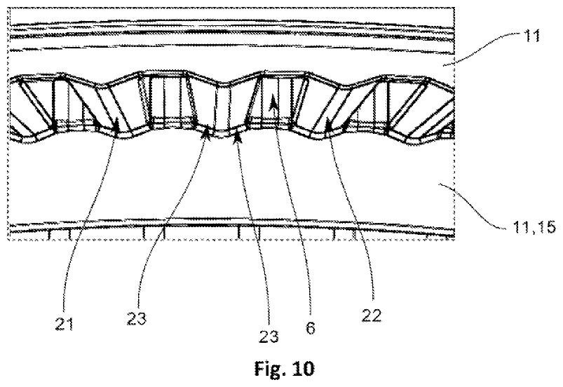

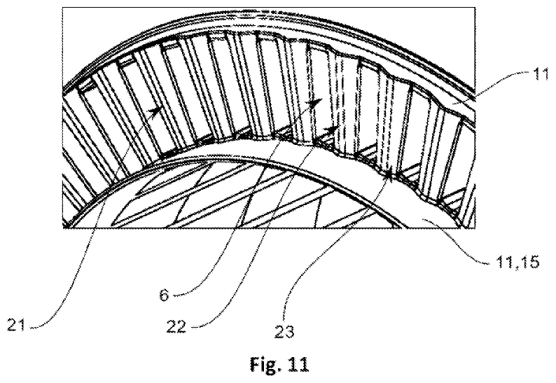

A combined view of FIG. 2 and FIGS. 9-11 also shows that a stator tooth 21 extending axially through the stator body 5 is formed circumferentially between two adjacent stator slots 6 in each case, and the plastic injection-molded element 11 covers an end face 22 of one or more stator teeth 21 in each case. The plastic injection-molded element 11 has a contour 23 which projects axially out of the end face 22 and which is used as a forming tool during the twisting of the corresponding winding head 9a, 9b.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define “first” and “second” features, this designation serves to distinguish between two features without necessarily defining an order of precedence.

### LIST OF REFERENCE SIGNS

1 Stator
2 Electric machine
3 Drive train
4 Motor vehicle
5 Stator body
6 Stator slots
7 Electrical conductor
8 Stator winding
9 Winding head
10 End faces
11 Plastic injection-molded element
12 Slot sidewalls
13 Slot base
14 Slot opening
15 Cylinder ring section
16 Cylinder ring section
17 Cylinder ring section
18 Cylinder ring section
19 Connecting section
20 Lateral surface
21 Stator tooth
22 End face
23 Contour
24 Outer diameter
25 Tool
26 Rotor

1. A stator of an electric machine, comprising:
a stator body having a plurality of stator slots which extend axially through the stator body;
a stator winding that includes a plurality of electrical conductors received within at least one of the plurality of stator slots, wherein the stator winding exits end face of the stator body to form at least one winding head; and
at least one plastic injection-molded element that is injection-molded at least one of into at least one of the plurality of stator slots and on to the stator body.

2. The stator of claim 1, wherein the stator slots each have slot sidewalls extending radially in cross-section and a slot base, wherein the at least one plastic injection-molded element completely covers the slot sidewalls and the slot base.

3. The stator of claim 2, wherein the stator slots each have a slot opening extending radially in cross-section, and wherein the at least one plastic injection-molded element closes the slot opening.

4. The stator of claim 1, wherein the at least one winding head includes a first winding head and a second winding head axially opposite the first winding head, and wherein the at least one plastic injection-molded element includes at least one of:
a first cylinder ring section which extends axially out of the stator body and which runs radially below the first winding head;
a second cylinder ring section which extends axially out of the stator body and which runs radially above the first winding head;
a third cylinder ring section which extends axially out of the stator body and which runs radially below the second winding head; and
a fourth cylinder ring section which extends axially out of the stator body and which runs radially above the second winding head.

5. The stator of claim 1, wherein the at least one plastic injection-molded element has a first connecting section which covers an outer lateral surface of the stator body at least in sections.

6. The stator of claim 1, wherein a stator tooth extending axially through the stator body is formed circumferentially between two adjacent stator slots in each case, and the at least one plastic injection-molded element covers an end face of one or more stator teeth in each case.

7. The stator of claim 1, wherein the at least one plastic injection-molded element has a contour which projects axially out of the end face and which is configured to be used as a forming tool during the twisting of the corresponding winding head.

8. The stator of claim 4, wherein at least one of:
the second cylinder ring section extending axially out of the stator body runs radially above the first winding head and radially below an outer diameter of the stator body; and
the fourth cylinder ring section extending axially out of the stator body runs radially above the second winding head and radially below the outer diameter of the stator body.

9. (canceled)

10. (canceled)

11. A method for producing a stator of an electric machine, comprising the steps of:
providing a stator that includes a stator body having a plurality of stator slots that extend axially through the stator body and are configured to receiving stator windings;
inserting the stator into an injection-molding tool of an injection-molding machine;
injection-molding at least one plastic injection-molded element that contacts the stator body; and
removing the stator from the injection-molding tool.

12. The method of claim 11, wherein the step of injection-molding the at least one plastic injection-molded element comprises injection-molding the at least one plastic injection-molded element such that the at least one plastic injection-molded element is disposed at least partially within at least one of the plurality of stator slots of the stator body.

13. The method of claim 11, wherein the step of injection-molding the at least one plastic injection-molded element comprises injection-molding the at least one plastic injection-molded element such that the at least one plastic injection-molded element is disposed on the stator body.

14. The method of claim 11, wherein the step of injection-molding the at least one plastic injection-molded element comprises injection-molding the at least one plastic injection-molded element such that slot sidewalls and a slot base of at least one of the plurality of stator slots are completely covered with the at least one plastic injection-molded element.

15. The method of claim 14, wherein the step of injection-molding the at least one plastic injection-molded element comprises injection-molding the at least one plastic injection-molded element such that the at least one plastic injection-molded element closes a slot opening of the at least one stator slot.

16. The method of claim 11, further comprising the step of:
utilizing a portion of the at least one plastic injection-molded element that projects axially out of an end face of the stator body as a forming tool during twisting of at least one winding head of the stator windings.

17. The method of claim 11, wherein the step of injection-molding the at least one plastic injection-molded element comprises injection-molding the at least one plastic injection-molded element such that a first connecting section of the at least one plastic injection-molded element is formed, the first connecting section covering an outer lateral surface of the stator body at least in sections.
